(19) United States
(12) Patent Application Publication
(10) Pub. No.: US 2009/0322968 A1
(43) Pub. Date: Dec. 31, 2009

(54) VIDEO PROJECTOR AND METHOD FOR CONTROLLING VIDEO PROJECTOR

(75) Inventor: Daisuke Kobayashi, Oume-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/411,215

(22) Filed: Mar. 25, 2009

(30) Foreign Application Priority Data
Jun. 25, 2008 (JP) 2008-166162

(51) Int. Cl. H04N 3/26

(52) U.S. Cl. 348/745; 348/E03.048

(57) ABSTRACT

A video projector includes: a signal processor; a display device; an optical unit configured to emit light for projecting an image displayed on a display screen of the display device toward a projection surface; and a detection module configured to detect an inclination, with respect to the projection surface, of an optical axis of the light emitted from the optical unit and a shake of the optical axis, wherein the signal processor includes: a distortion correction module configured to correct distortion of the image displayed on the projection surface to display a distortion-corrected image; and a blur correction module configured to correct blur of the image displayed on the projection surface, and wherein the distortion correction module corrects a position and size of the distortion-corrected image so that a blank area is provided around the distortion-corrected image.

### CROSS REFERENCE TO RELATED APPLICATION(S)

The present disclosure relates to the subject matters contained in Japanese Patent Application No. 2008-166162 filed on Jun. 25, 2008, which are incorporated herein by reference in its entirety.

### FIELD

The present invention relates to a video projector having a distortion correction function and a method for controlling the video projector.

### BACKGROUND

A video projector is provided with: a front end that performs A/D conversion and the like on an input video signal; a signal processor that performs various processing on the signal output from the front end; a display device that displays an image, on a display screen, in accordance with the video signal supplied from the signal processor; and an optical unit that includes a light source, a prism, and an optical lens, and projects the image displayed on the display onto a projection surface.

Thus configured video projector is placed on a desk or hung from a ceiling for use. When the projection surface is not perpendicular to the optical axis of the image projected from the projection optical unit of the video projector, the image displayed on the projection surface is distorted.

There may be a case where, while an image is being projected, a person passes by the desk where the video projector is placed or takes notes on the desk to shake the video projector. This causes the image blurred and not easy to view.

Conventionally, there is proposed a handheld video projector capable of correcting image blur caused by unintentional hand movement. An example of such handheld video projector is disclosed in W05/083507 (counterpart U.S. publication is: US 2007/0120983 A1).

However, the handheld video projector performs image blur correction by moving a lens which is provided as an image blur correction optical system. For example, when image blur correction is performed under a state where trapezoidal distortion correction is performed with respect to the bottom of the screen as shown in FIG. 5, there are cases where the image is partly forced out of the frame and part of the image is not displayed according to the shake amount and the shake direction.

### SUMMARY

Therefore, one of objects of the invention is to provide a video projector that suppresses the image being forced out of the frame when distortion correction and image blur correction are performed.

According to a first aspect of the present invention, there is provided a video projector including: a signal processor configured to perform signal processing on an input video signal; a display device configured to display an image on a display screen in accordance with a signal no output from the signal processor; an optical unit configured to emit light for projecting the image displayed on the display screen toward a projection surface; and a detection module configured to detect an inclination, with respect to the projection surface, of an optical axis of the light emitted from the optical unit and a shake of the optical axis, wherein the signal processor includes: a distortion correction module configured to correct distortion of the image displayed on the projection surface to display a distortion-corrected image on the projection surface, the distortion being caused when the optical axis and the projection surface are not substantially orthogonal to each other; and a blur correction module configured to correct blur of the image displayed on the projection surface when the shake of the optical axis is detected by the detection module, and wherein the distortion correction module corrects a position and size of the distortion-corrected image so that a blank area is provided around the distortion-corrected image.

According to a second aspect of the present invention, there is provided a method for controlling a video projector, the method including: detecting an inclination, with respect to a projection surface, of an optical axis of light emitted from an optical unit and a shake of the optical axis; correcting distortion of an image displayed on the projection surface to display a distortion-correction image on the projection surface, the distortion being caused when the optical axis and the projection surface are not substantially orthogonal to each other, from the detected inclination and the detected shake; correcting blur of the image displayed on the projection surface when the shake of the optical axis is detected; and correcting a position and size of the distortion-corrected image so that a blank area is provided around the distortion-corrected image.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a view for explaining a structural example of a video projector according to an embodiment of the present invention.

FIG. 2 is a view for explaining a use example of the video projector according to the embodiment of the present invention.

FIG. 3 is a view showing an examples (A) (B) of an image of before distortion correction and an image of after distortion correction by the video projector according to the embodiment of the present invention.

FIG. 4 is a view for explaining an example of the distortion correction by the video projector according to the embodiment of the present invention and a method of adjusting the position and size of the distortion-corrected image.

FIG. 5 is a view for explaining an example of an inclination and shake detection method in the video projector according to the embodiment of the present invention.

FIG. 6 is a view showing examples of a projected image when the blur, in the vertical direction, of the distortion-corrected image is corrected without the position and size thereof corrected.

FIG. 7 is a view showing examples of the projected image when the blur in the vertical direction is corrected by the video projector according to the embodiment of the present invention.

FIG. 8 is a flowchart for explaining an example of a method of controlling the video projector according to the embodiment of the present invention.

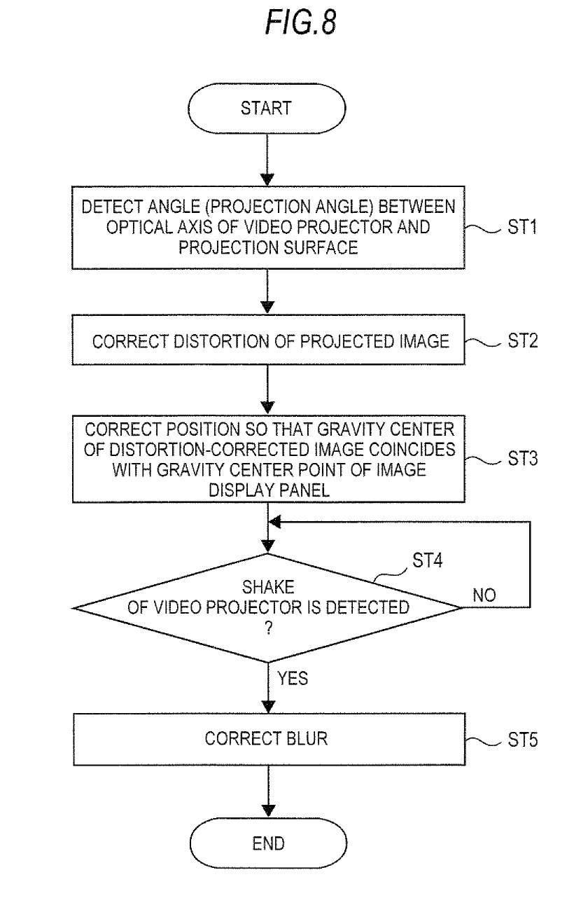

### DETAILED DESCRIPTION OF THE EMBODIMENTS

Hereinafter, a video projector and a method for controlling the video projector according to an embodiment of the present invention will be described with reference to the drawings.

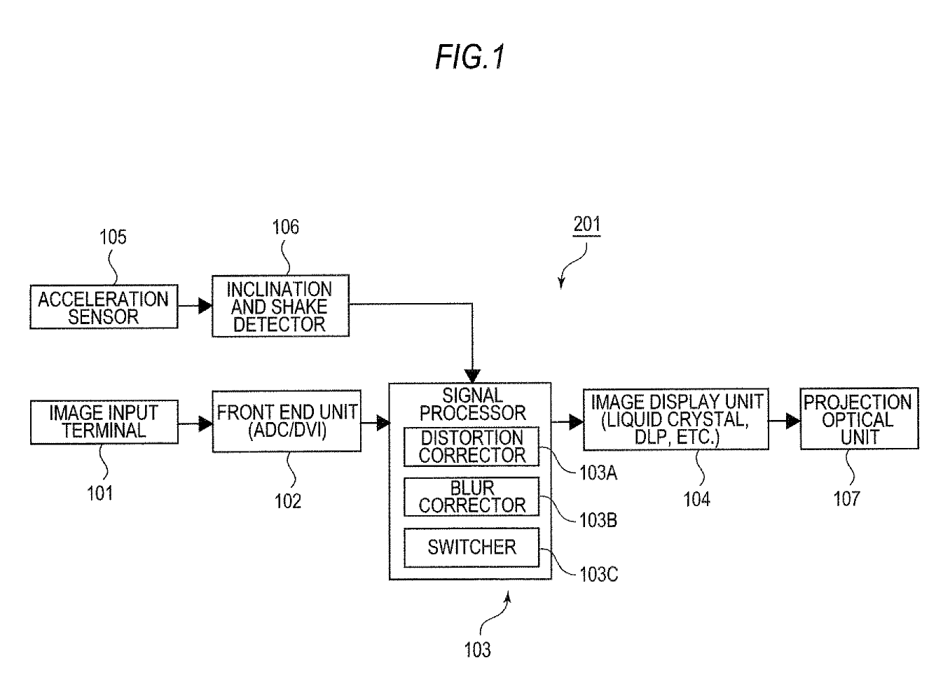

As shown in FIG. 1, a video projector 201 according to the present embodiment is provided with: an image input terminal 101 where a video signal is input from an external computer and the like; and a front end unit 102 that performs A/D conversion on the analog video signal input from the image input terminal 101 and decodes the video signal from a DVI (digital visual interface) or an HDMI (high-definition multimedia interface) which signal is input by the TMDS (transition minimized differential signaling) method.

The video projector 201 is further provided with: an acceleration sensor 105 as the PWM wave output module; and an inclination and shake detector 106 as the detection module for detecting the inclination, with respect to the projection surface, of the optical axis of the light emitted from the video projector 201 and the shake of the optical axis, from the signal output from the acceleration sensor. In the video projector 201 according to the present embodiment, the acceleration sensor 105 outputs a PWM wave of a duty ratio (pulse width/pulse period) corresponding to the inclination of the optical axis 204 of the video projector 201 and the shake of the optical axis 204 as described later.

The video projector 201 is provided with a signal processor 103 supplied with the output signals of the front end unit 102 and the inclination and shake detector 106. The signal processor 103 processes the digital video signal supplied from the front end unit 102, so as to be displayable on an image display unit 104, and outputs the processed signal.

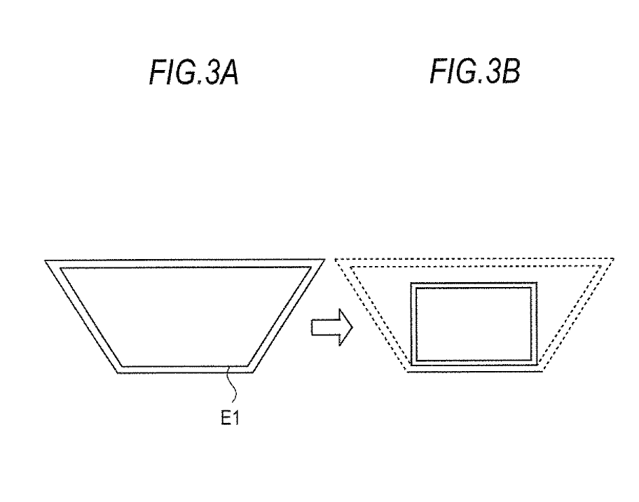

The signal processor 103 is provided with: a distortion corrector 103A that performs distortion correction of the digital video signal supplied from the front end unit 102 in response to the output signal from the inclination and shake detector 106; a blur corrector 103B that performs blur correction; and a switcher 103C that switches whether to perform blur correction or not. For example, when trapezoidal distortion is caused as shown in FIG. 3, the distortion corrector of the signal processor 103 corrects the entire image with respect to a lower part (the base E1 of the trapezoid) of the image where distortion is small.

The image display unit 104 is a liquid crystal display panel that displays the video signal supplied from the signal processor 103, on a display screen DYP. A projection optical unit 107 includes a light source, a prism, and an optical lens, and projects the image to displayed on the image display unit 104, onto a projection surface 207.

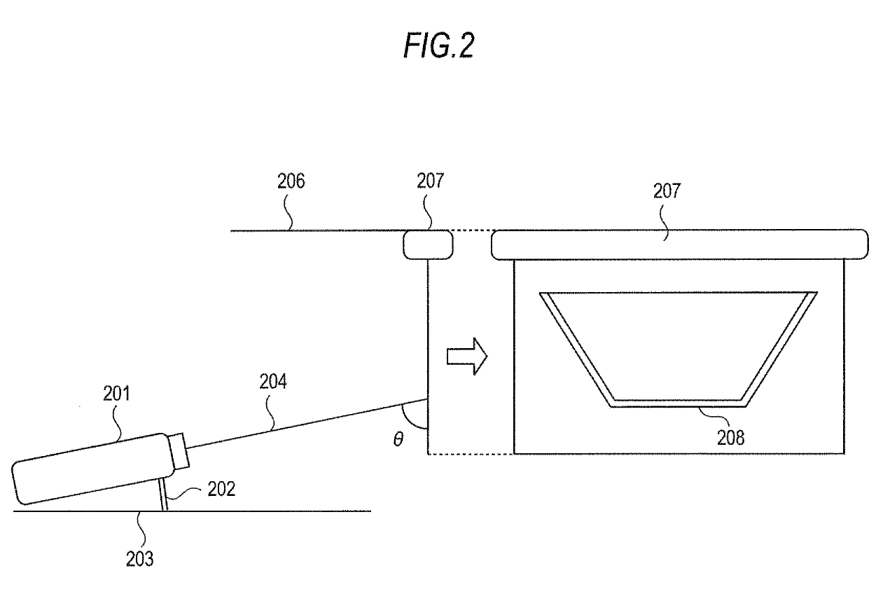

FIG. 2 is a view showing an example of use of the above-described video projector 201. The video projector 201 is placed on a table 203, and an image is projected onto the screen 207 (projection surface) hung from a ceiling 206.

At this time, when adjustment is made by an adjustment foot 202 of the video projector 201 so that the optical axis 204 of the video projector 201 is situated at the center of the screen 207, the angle θ between the optical axis 204 and the screen 207 is not a right angle. Therefore, the projected image 208 of, for example, a substantially rectangular image output from the video projector 201 is distorted into a trapezoid because the projection angle θ is not a substantially right angle.

FIG. 3 is a view showing a case where the projected image 208 distorted into trapezoid shape is corrected to the aspect size of the substantially rectangular original image. Section (A) shown in FIG. 3 shows the projected image of before the trapezoidal distortion correction. Section (B) shown in FIG. 3 shows a result of distortion-correcting the projected image shown in section (A) in FIG. 3 so that the aspect ratio is the same as that of the original image with respect to the base E1 of the trapezoid where the optical distortion is small.

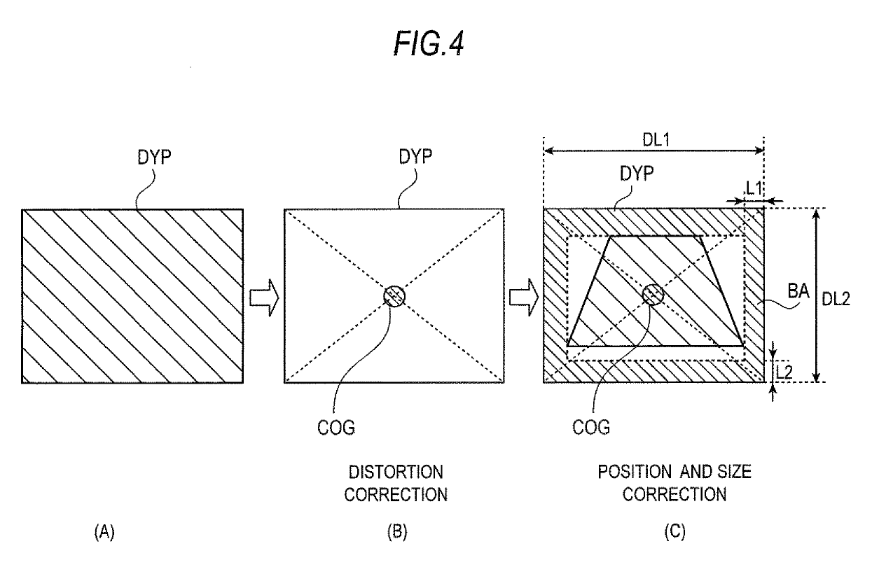

Here, the distortion corrector 103A of the signal processor 103 corrects the position and size of the image so that a blank area BA is provided around the distortion-corrected projected image. For example, when a substantially rectangular image is displayed on the display screen DYP of the liquid crystal panel 104 as shown in section (A) of FIG. 4, distortion correction is performed with respect to a part where the image distortion is small as shown in section (B) of FIG. 4.

The distortion corrector 103A corrects the position and size of the image so that the blank area BA is provided around the distortion-corrected image as shown in section (C) of FIG. 4. For example, the blank area BA shown in FIG. 4 may be black or white solid display or an image as the background of the projected image may be displayed.

Specifically, the distortion corrector 103R corrects the position of the projected image so that the gravity center point COG of the display screen DYP of the image display unit 104 and the gravity center of the distortion-corrected projected image coincide with each other. Here, the gravity center point of the image display unit 104 is constituted by the gravity center of the display screen GYP of the liquid crystal panel and an area of a plurality of pixels surrounding the gravity center. It is desirable that the gravity center point be an area constituted by the gravity center and four pixels surrounding the gravity center.

Further, it is desirable that the width L1 of the blank area BA in the direction of the length be two pixels or more. Likewise, it is desirable that the width L2 of the blank area in the direction substantially orthogonal to the direction of the length be two pixel lines or more.

At this time, when the size of the blank area BA is outside the desired range, the signal processor 103 can provide the blank area BA of an appropriate size by reducing the projected image.

For example, when the user gives higher priority to image quality than to the provision of the blank area BA of an appropriate size, setting can be made so that the signal processor 103 adjusts only the position of the projected image without reducing the size of the projected image.

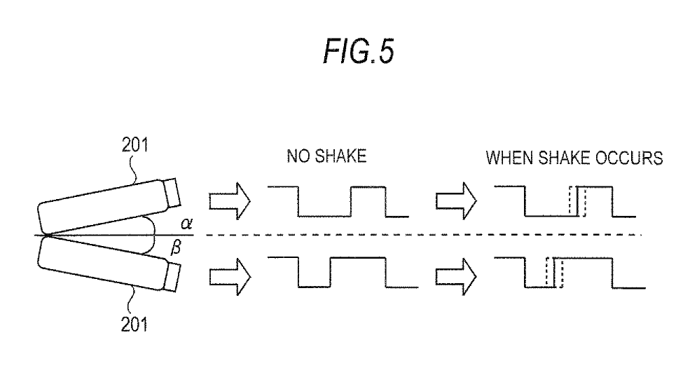

FIG. 5 is a view showing the output waveform of the acceleration sensor 105 according to the inclination angle of the video projector 201 and the output waveform of the acceleration sensor 105 when a shake occurs. The inclination angle and shake of the video projector 201 are detected, for example, by the output signal waveform of the acceleration sensor 105 being changed as shown in FIG. 5.

The acceleration sensor 105 of the video projector 201 according to the present embodiment outputs a PWM (pulse width modulation) wave. In the present embodiment, when the inclination angles α and β of the video projector 201 are 0 (zero), the duty ratio of the output waveform of the acceleration sensor 105 is 50/50. When the inclination angles α and β of the video projector 201 are changed, the duty ratio of the output waveform of the acceleration sensor 105 is changed according to the change of the angles.

The inclination and shake detector 106 detects the inclination angle of the video projector 201 based on the duty ratio of the PWM wave output from the acceleration sensor 105. In the case shown in FIG. 5, for example, when the inclination angle of the video projector 201 is α, in cases where the video projector 201 is not shaking, the duty ratio of the PWM wave output from the acceleration sensor 105 is approximately 70/30.

Therefore, when the duty ratio of the PWM wave output from the acceleration sensor 105 is approximately 70/30, the inclination and shake detector 106 detects that the inclination angle of the video projector 201 is α.

For example, when the inclination angle of the video projector 201 is β, in cases where the video projector 201 is not shaking, the duty ratio of the PWM wave output from the acceleration sensor 105 is approximately 30/70.

Therefore, when the duty ratio of the PWM wave output from the acceleration sensor 105 is approximately 30/70, the inclination and shake detector 106 detects that the inclination angle of the video projector 201 is β.

At this time, when the video projector 201 shakes, the optical axis 204 of the light emitted from the video projector 201 also shakes, so that the duty ratio of the PWM wave output from the acceleration sensor 105 changes so as to finely shake with respect to the duty ratio of the PWM wave before the shake occurs. When the duty ratio of the PWM wave changes so as to finely shake like this, the inclination and shake detector 106 detects the shake of the optical axis 204 of the video projector 201.

The signal processor 103 corrects the distortion of the projected image according to the inclination angle detected by the inclination and shake detector 106. For example, the larger the inclination angle is, the larger the distortion of the image projected on the side of the inclination direction of the video projector 201, so that the distortion corrector 103A adjusts the distortion correction amount according to the inclination angle of the optical axis 204.

Further, when a shake occurs, since the duty ratio of the PWM wave changes to and fro with respect to the duty ratio before the shake occurs, the blur corrector 103B of the signal processor 103 corrects the blur of the projected image by moving the projected image by changing the width of the synchronization signal and the phase of the synchronization signal with respect to the input video signal according to the change amount of the duty ratio.

The signal processor 103 of the video projector according to the present embodiment has a switcher 103C capable of switching between a mode in which blur correction is performed and a mode in which no blur correction is performed. It is to be noted that the signal processor 103 can be structured so as to always perform blur correction when a shake occurs.

When a projected image is corrected by the above-described video projector 201, as shown in FIG. 5, the inclination and shake detector 106 detects the angle between the optical axis 204 of the light emitted from the video projector 201 and the projection surface 207 from the output signal of the acceleration sensor 105 (step ST1).

The signal processor 103 corrects the distortion of the projected image as shown in section (B) of FIG. 4 based on the result of the detection by the inclination and shake detector 106 (step ST2). At this time, the signal processor 103 corrects the distortion of the projected image with respect to the least distorted part so that the aspect ratio is the same as that of the current image.

Then, the signal processor 103 adjusts the position and size of the distortion-corrected projected image so that the blank area BA of a predetermined size is provided around the projected image (step ST3).

When the signal processor 103 detects a shake of the video projector 201 under this state (step ST4), the signal processor 103 corrects the blur of the projected image according to the size and direction of the detected shake (step ST5).

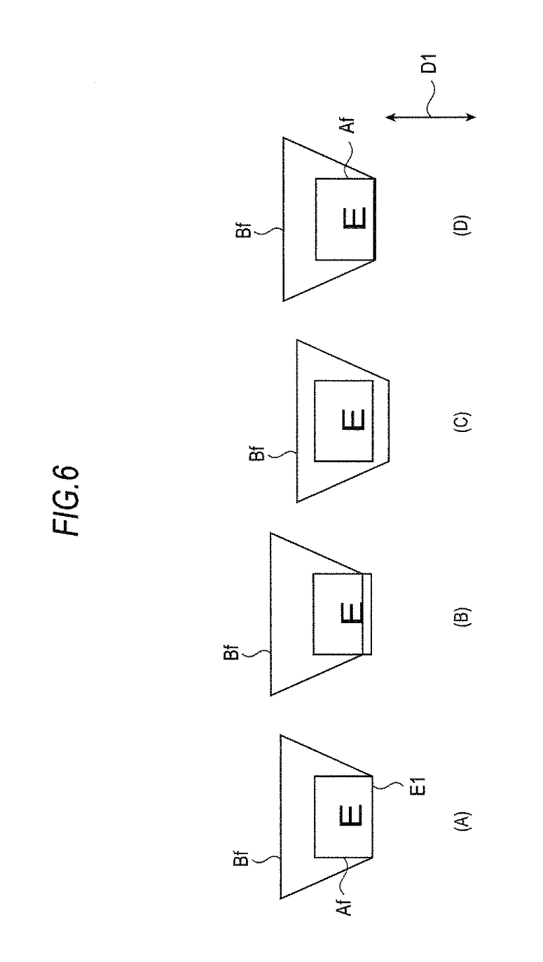

Now, for example, a case where distortion correction is performed on an image Bf of before distortion correction and blur correction is performed on the distortion-corrected image Af as shown in sections (A) through (D) of FIG. 6, that is, a case where a shake occurs in the vertical (up-and-down) direction Dl when distortion correction is performed on the projected image with respect to a lower part (the base E1) of the projected image where distortion is small as shown in section (A) of FIG. 6 will be described below.

Sections (A) and (D) of FIG. 6 show states where no blur correction is performed (neutral positions), and sections (S) and (C) of FIG. 6 show states where the inclination and shake detector 106 detects that the optical axis 204 of the video projector 201 shakes upward (shown in section (B)) and downward (shown in section (C)) and the signal processor 103 corrects the position of the projected image according to the detected shake amount and shake direction.

In a case where the video projector 201 shakes upward and the projected image is moved downward to correct the blur corresponding to the shake direction when distortion correction is performed with respect to the base E1 of the projected image, as shown in section (B) of FIG. 6, the projected image is partly forced out of the display screen of the image display unit 104.

Therefore, for example, in a case where an image displaying a letter “E” is projected as shown in section (B) of FIG. 6, when it is detected that the optical axis 204 of the video projector 201 shakes upward, there are cases where the performance of blur correction makes part of the image undisplayed and the letter is erroneously visually recognized as “F”.

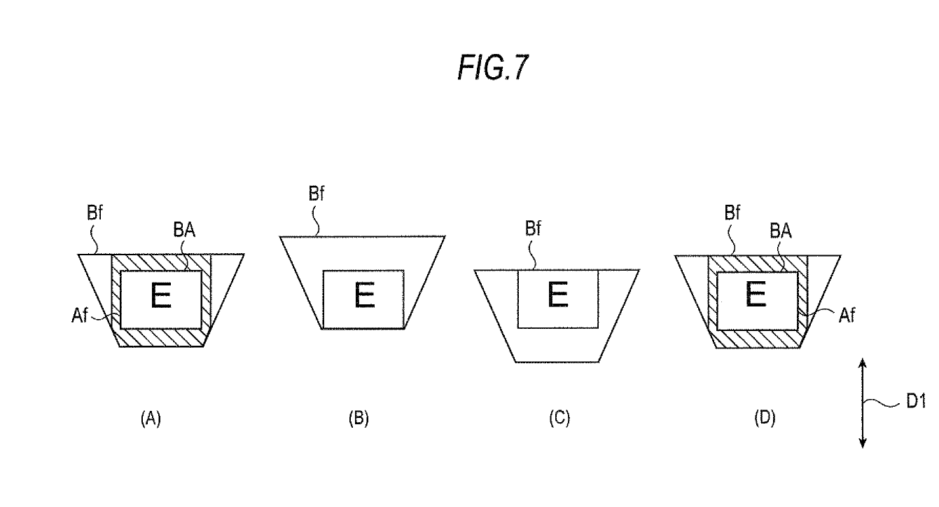

On the contrary, by correcting the position and size of the image so that the blank area BA is provided around the distortion-corrected image Af as shown in sections (A) through (D) of FIG. 7, the projected image would not be forced out of the display screen even if blur correction is performed.

Sections (A) and (C) of FIG. 7 show states where no blur correction is performed (neutral position), and sections (B) and (C) of FIG. 7 show states where the video projector 201 is shaken upward (section (B)) and downward (section (C)), the inclination and shake detector 106 detects the shake of the optical axis 204, and the signal processor 103 corrects the position of the projected image according to the detected shake amount and shake direction.

Comparing the states shown in section (B) of FIG. 6 and section (B) of FIG. 7, the part that is forced out of the frame in the state shown in section (B) of FIG. 6 can be displayed in the state shown in section (B) of FIG. 7, so that even if the corrected projected image Af is moved downward as shown section (B) in FIG. 7, the displayed image would not be erroneously recognized.

That is, by moving the image having undergone the trapezoidal distortion correction as shown in FIG. 4 with respect to the gravity center point of the display screen DYP, the blank area BA can be secured in upper, lower, right and left parts, so that the number of pixels that are forced out of the frame when blur correction is performed can be reduced as shown in FIG. 7.

While the inclination of the optical axis 204 of the video projector 201 and the shake of the optical axis 204 are detected based on the PWM wave in the video projector 201 of the present embodiment, the means for detecting the inclination of the optical axis 204 of the video projector 201 and the shake of the optical axis 204 is not limited thereto.

For example, an analog signal or a signal compliant with a serial bus such as SPI (serial peripheral interface) may be used as well as the PWM wave. In the case of the analog signal, the output signal of the acceleration sensor 105 is converted to a digital signal by an A/D converter, and used for the inclination and shake detection. In the case of the signal compliant with the serial bus, the output signal of the acceleration sensor 105 is decoded by a decoder, and used for the inclination and shake detection. Moreover, the inclination of the optical axis 204 and the shake of the optical axis 204 may be detected based on different signals. Further, the inclination of the optical axis 204 and the shake of the optical axis 204 may be detected based on a combination of these signals.

When the PWM wave is used as in the video projector according to the above-described embodiment, since the PWM wave is sampled at a predetermined timing in performing the inclination and shake detection, the number of connection terminals can be reduced.

Moreover, while the video projector 201 according to the present embodiment is used by being placed on the table 203 and adjusted by the adjustment foot 202 so that the optical axis 204 of the video projector 201 is situated at the center of the screen 207, the video projector 201 may be one that can be used by being hand-held.

For example, an ultra-compact hand-held video projector has been proposed in which raster scanning of an MEMS (micro electro mechanical systems) mirror is performed and a laser is used as the light source, and the video projector according to the above-described embodiment may be a hand-held video projector as described above.

Even in hand-held video projectors, by providing the blank area BA around the projected image as described above and correcting the blur (movement of the hands) caused when projection is performed with the video projector being hand-held, similar effects to those obtained by the video projector and the method of controlling the video projector according to the above-described embodiment are obtained.

While whether to perform blur correction or not can be set by the switcher 103C of the signal processor 103 in the video projector according to the above-described embodiment, a structure may be adopted in which the blank area BA is not provided around the image when the user makes switching to a mode in which no blur correction is performed. In that case, when no blur correction is performed, it is not performed to reduce the image to provide the blank area BA, so that a higher quality image can be projected.

As described above with reference to the embodiment, there is provided a video projector capable of preventing the image from being forced out of the frame when distortion correction and blur correction are performed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video projector comprising:
a signal processor configured to perform signal processing on an input video signal;
a display device configured to display an image on a display screen in accordance with a signal output from the signal processor;
an optical unit configured to emit light for projecting the image displayed on the display screen toward a projection surface; and
a detection module configured to detect an inclination, with respect to the projection surface, of an optical axis of the light emitted from the optical unit and a shake of the optical axis,
wherein the signal processor comprises:
a distortion correction module configured to correct distortion of the image displayed on the projection surface to display a distortion-corrected image on the projection surface, the distortion being caused when the optical axis and the projection surface are not substantially orthogonal to each other; and
a blur correction module configured to correct blur of the image displayed on the projection surface when the shake of the optical axis is detected by the detection module, and
wherein the distortion correction module corrects a position and size of the distortion-corrected image so that a blank area is provided around the distortion-corrected image.

2. The video projector of claim 1, wherein the distortion correction module corrects the position of the distortion-corrected image so that a gravity center point of the display screen coincides with a gravity center of the distortion-corrected image.

3. The video projector of claim 1 further comprising a PWM wave output module configured to output a PWM wave,
wherein the detection module comprises a PWM wave detection module configured to detect at least one of the inclination of the optical axis and the shake of the optical axis from a waveform of the PWM wave output from the PWM wave output module.

4. The video protector of claim 1, wherein the signal processor further comprises a switching module configured to switch between a first mode in which blur correction is performed based on a result of the detection by the detection module and a second mode in which no blur correction is performed.

5. A method for controlling a video projector, the method comprising:
detecting an inclination, with respect to a projection surface, of an optical axis of light emitted from an optical unit and a shake of the optical axis;
correcting distortion of an image displayed on the projection surface to display a distortion-correction image on the projection surface, the distortion being caused when the optical axis and the projection surface are not substantially orthogonal to each other, from the detected inclination and the detected shake;
correcting blur of the image displayed on the projection surface when the shake of the optical axis is detected; and
correcting a position and size of the distortion-corrected image so that a blank area is provided around the distortion-corrected image.

6. The method of claim 5, wherein the position of the distortion-corrected image is corrected so that a gravity center point of the display screen coincides with a gravity center of the distortion-corrected image.

7. The method of claim 5, wherein at least one of the inclination of the optical axis and the shake of the optical axis is detected from a waveform of a PWM wave output from a PWM wave output module.
